(19) United States
(12) Patent Application Publication
(10) Pub. No.: US 2009/0117026 A1
(43) Pub. Date: May 7, 2009

(54) Method for manufacturing carbon nano-tube

(75) Inventors: Tomohiro Shimazu, Kariya-city (JP); Yoshinobu Suzuki, Aichi-gun (JP); Hisayoshi Oshima, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/285,171

(22) Filed: Sep. 30, 2008

(30) Foreign Application Priority Data
Oct. 1, 2007 (JP) 2007-257854
Sep. 3, 2008 (JP) 2008-226408

(51) Int. Cl. D01F 9/127; B82B 3/00; B82B 1/00

(52) U.S. Cl. 423/447.7; 977/742; 977/843

(57) ABSTRACT

A method for manufacturing a carbon nano-tube by a chemical vapor deposition includes: introducing a carbon source gas into a reaction chamber; growing the carbon nano-tube by using a catalyser; and maintaining a pressure of the carbon source gas in the reaction chamber in a range between 1.0 Torr and 2.0 Torr so that the carbon nano-tube is formed. Since the pressure is maintained in a range between 1.0 Torr and 2.0 Torr, the catalyser is not caulked. Thus, the carbon nano-tube is stably formed.

### CROSS REFERENCE TO RELATED APPLICATIONS

This application is based on Japanese Patent Applications No. 2007-257854 filed on Oct. 1, 2007, and No. 2008-226408 filed on Sep. 3, 2008, the disclosures of which are incorporated herein by reference.

### FIELD OF THE INVENTION

The present invention relates to a method for manufacturing a carbon nano-tube by a chemical vapor deposition.

### BACKGROUND OF THE INVENTION

A carbon nano-tube has a structure having a cylindrical shape. Specifically, carbon atoms are coupled by a sp2 bonding so that they provide a six-membered ring. Multiple six-membered rings form a network so that a graphite sheet is formed. The graphite sheet is rounded to form a closed cylindrical shape. Thus, the carbon nano-tube has a diameter in a range between a few nanometers and a few tens nanometers. The carbon nano-tube is made of carbon.

The carbon nano-tube has strong chemical structure that is very stable. The conductivity of the carbon nano-tube depends on a helical degree of a hexagonal lattice composing the carbon nano-tube so that the carbon nano-tube may become good conductor or semiconductor. Thus, the carbon nano-tube has various physical properties.

The carbon nano-tube has excellent electric properties, thermal conductivity and mechanical strength. In view of these characteristics, the carbon nano-tube is used for thermal equipment, electronic equipment, electric equipment and the like so that the application of the carbon nano-tube has been studied.

One of methods for synthesizing the carbon nano-tube is a thermal CVD (i.e., chemical vapor deposition) method for manufacturing the carbon nano-tube by pyrolytically decomposing gas as carbon source. The large amount of the carbon nano-tube is formed by the CVD method.

Further, in a conventional art, to form the carbon nano-tube on a substrate with a vertically oriented manner, the carbon nano-tube is synthesized such that the substrate having catalyser is arranged in a reaction tube, and raw material gas as the carbon source is introduced into the reaction tube so that the gas reaches the heated catalyser. The reaction tube is arranged in a tubular furnace. This technique is disclosed in JP-A-2001-220674.

When the carbon nano-tube is formed on the substrate, a length of the carbon nano-tube is in proportion to time in the early stage of the synthesis.

After elapse of a few minutes to a few tens minutes from the beginning of growth of the carbon nano-tube, amorphous carbon may be formed on the catalyser so that the catalyser is caulked. Thus, the catalyser loses activity for forming the carbon nano-tube. Therefore, the length of the carbon nano-tube is limited to be equal to or shorter than a few tens micro meters.

To lengthen the carbon nano-tube, thermal decomposition is promoted by encapsulating the carbon source in the reaction. Further, synthesis of the carbon nano-tube is repeated so that the length of the carbon nano-tube increases.

However, when the amorphous carbon is formed on the catalyser so that the catalyser is caulked, the carbon nano-tube is not lengthened even if the synthesis is repeated.

Thus, it is required to continue to form the carbon nano-tube stably so that the length of the carbon nano-tube increases.

### SUMMARY OF THE INVENTION

In view of the above-described problem, it is an object of the present disclosure to provide a method for manufacturing a carbon nano-tube.

According to a first aspect of the present disclosure, a method for manufacturing a carbon nano-tube by a chemical vapor deposition includes: introducing a carbon source gas into a reaction chamber; growing the carbon nano-tube by using a catalyser; and maintaining a pressure of the carbon source gas in the reaction chamber in a range between 1.0 Torr and 2.0 Torr so that the carbon nano-tube is formed. Since the pressure is maintained in a range between 1.0 Torr and 2.0 Torr, the catalyser is not caulked. Thus, the carbon nano-tube is stably formed.

According to a second aspect of the present disclosure, a method for manufacturing a carbon nano-tube by a chemical vapor deposition includes: introducing a carbon source gas into a reaction chamber; growing the carbon nano-tube by using a catalyser; maintaining a pressure of the carbon source gas in the reaction chamber in a range between 1.0 Torr and 2.0 Torr so that the carbon nano-tube is formed; and removing an amorphous carbon attached on the catalyser with an oxidized gas after the maintaining the pressure. The maintaining the pressure is performed after the maintaining the pressure and the removing the amorphous carbon are alternately repeated at least one time. Since the catalyser is activated again so that the activity of the catalyser is maintained to be high, the carbon nano-tube having the large fiber length is formed.

According to a third aspect of the present disclosure, a method for manufacturing a carbon nano-tube by a chemical vapor deposition includes: introducing a carbon source gas into a reaction chamber; growing the carbon nano-tube by using a catalyser; maintaining a pressure of the carbon source gas in the reaction chamber in a range between 1.0 Torr and 2.0 Torr so that the carbon nano-tube is formed; removing an amorphous carbon attached on the catalyser with an oxidized gas after the maintaining the pressure; and reducing the catalyser with a reducing gas after the removing the amorphous carbon. The maintaining the pressure is performed after the maintaining the pressure, the removing the amorphous carbon and the reducing the catalyser are alternately repeated at least one time. Since the amorphous carbon near the catalyser is removed, the catalyser is activated again. The catalyser may be oxidized by the oxidized gas, so that the catalyser is inactivated. In the reducing the catalyser, the oxidized catalyser is reduced by the reducing gas. Therefore, the oxidized catalyser is activated again. Thus, the activity of the catalyser is maintained to be high, and thereby, the carbon nano-tube having the large fiber length is formed.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing carbon nano-tube manufacturing equipment according to a first embodiment;

FIG. 2 is a graph showing a relationship between a EtOH pressure and a fiber length of the carbon nano-tube according to the first embodiment;

FIG. 3 is a schematic view showing carbon nano-tube manufacturing equipment according to a second embodiment;

FIG. 4 is a graph showing a manufacturing method of a carbon nano-tube according to the second embodiment;

FIG. 5 is a graph showing a relationship between a EtOH pressure and a fiber length of the carbon nano-tube according to the second embodiment;

FIG. 6 is a graph showing a manufacturing method of a carbon nano-tube according to a third embodiment; and

FIG. 7 is a graph showing a relationship between a EtOH pressure and a fiber length of the carbon nano-tube according to the third embodiment.

### DETAILED DESCRIPTION OF THE PREFERRED EMBODIMENTS

### First Embodiment

Carbon nano-tube (i.e., CNT) manufacturing equipment used for a carbon nano-tube manufacturing method will be explained.

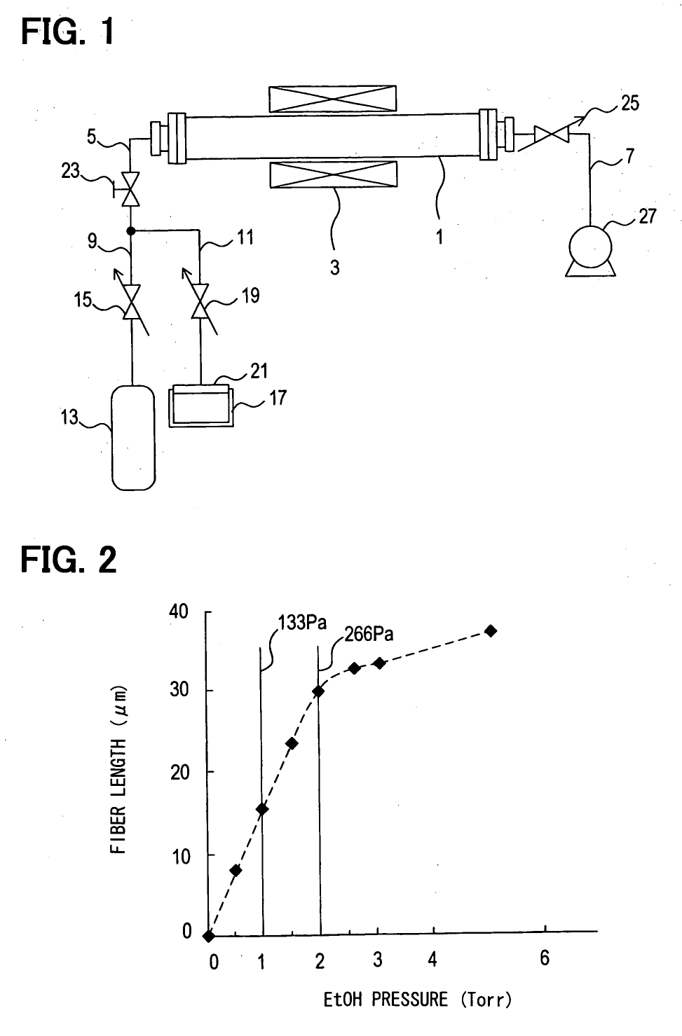

As shown in FIG. 1, the equipment includes a reaction tube 1, a ring shaped electric furnace 3, a gas supply pipe 5 and a gas discharge pipe 7. In the reaction tube 1, the vertically-oriented carbon nano-tube is formed by a chemical vapor deposition method. The ring shaped electric furnace 3 is disposed around the reaction tube 1 so that the furnace 3 heats the reaction tube 1. The gas supply pipe 5 supplies a raw material gas as a carbon source to the reaction tube 1. The gas discharge pipe 7 discharges the gas from the reaction tube 1 after the gas reacts in the reaction tube 1.

The gas supply pipe 5 is connected to both of a first gas supply pipe 9 and a second gas supply pipe 11. The first gas supply pipe 9 supplies carrier gas including hydrogen gas and argon gas. The second gas supply pipe 11 supplies ethanol gas as carbon source.

The first gas supply pipe 9 is coupled with a carrier gas cylinder 13 via a first valve 15. In the carrier gas cylinder 13, the carrier gas is filled. The first valve 15 adjusts the flowing amount of the carrier gas.

The second gas supply pipe 11 is coupled with an ethanol vessel 17 via a second valve 19. The ethanol is stored in the vessel 17. The second valve 19 adjusts the ethanol gas flow amount. A heater 21 for holding the temperature of the ethanol is formed on the vessel 17.

In the gas supply pipe 5, a third valve 23 is arranged between the reaction tube 1 and the first and second gas supply pipes 9, 11. Specifically, the third valve 23 is disposed on a downstream side from a connection between the gas supply pipe 5 and the second gas supply pipe 11. The third valve 23 opens and closes the pipe 5 to supply and to stop supplying the gas in the reaction tube 1.

In the gas discharge pipe 7, a fourth valve 25 is arranged between the reaction tube 1 and a vacuum pump 27. Specifically, the vacuum pump 27 is disposed on the downstream side from the fourth valve 25. The fourth valve 25 adjusts the gas flow amount discharged from the reaction tube 1. The vacuum pump 27 vacuates the inside of the reaction tube 1.

The first to fourth valves 15, 19, 23, 25 are electro-magnetic valves for opening and closing the pipes 5, 7, 9, 11 based on instruction signals from electronic controller (not shown). Alternatively, the valves 15, 19, 23, 25 may be operated manually.

The manufacturing method of the carbon nano-tube will be explained.

Here, the raw material gas as the carbon source is the ethanol gas. The carrier gas is the hydrogen gas and the argon gas. The hydrogen concentration in the carrier gas is 3.0 wt %.

A substrate made of quartz is arranged in the reaction tube 1. The substrate is horizontally arranged in the tube 1. A catalyser for growing the carbon nano-tube is applied on the surface of the substrate. The catalyser is made of cobalt (Co), molybdenum (Mo), alloy of cobalt and molybdenum, cobalt oxide (e.g., CoO) or molybdenum oxide (e.g., MoO₂). In the present embodiment, the catalyser is made of cobalt.

First, the fourth valve 25 is opened, and the pump 27 is started to operate so that the reaction tube 1 is evacuated.

Then, the opening degree of each of the first, third and fourth valves 15, 23, is controlled so that the carrier gas is flown with a flow rate of 300 sccm in the reaction tube 1. The inner pressure of the reaction tube 1 is kept at 300 Torr (i.e., 39.9 kPa). The temperature of the substrate is increased up to 840° C., which is the growth temperature of the carbon nano-tube.

Next, the first valve 15 is closed, and the reaction tube 1 is evacuated.

Then, the opening degree of each of the first to fourth valves 15, 19, 23, 25 is controlled so that the ethanol gas and the carrier gas are introduced in the reaction tube 1 with predetermined gas flow amounts, respectively. Thus, the inner pressure of the reaction tube 1 is maintained to 2.0 Torr (i.e., 266 Pa). Specifically, the gas flow amount of the ethanol gas is 20 sccm, and the gas flow amount of the carrier gas is 20 sccm. The partial pressure of the ethanol gas is maintained to 1.0 Torr (i.e., 133 Pa).

Here, pressure is measured by a device of Baratron 227A made by MK Sinstruments.

The substrate temperature is maintained at 840° C., and the carbon nano-tube is grown on the substrate for 60 minutes. The vertically-oriented carbon nano-tube having a fiber length is obtained, as shown in FIG. 2.

Here, the partial pressure of the ethanol gas is changed so that the relationship between the ethanol partial pressure and the fiber length of the carbon nano-tube is measured.

Thus, the partial pressure of the ethanol gas is maintained to 1.0 Torr-2.0 Torr (i.e., 133 Pa to 266 Pa), which is lower than a conventional partial pressure. Thus, amorphous carbon is limited to generate on the substrate, so that the carbon nano-tube is preferably formed on the substrate.

When the ethanol partial pressure is in a range between 1.0 Torr and 2.0 Torr, the fiber length of the carbon nano-tube is increased in proportion to the partial pressure. However, when the ethanol partial pressure is higher than 2.0 Torr, the fiber length of the carbon nano-tube is not proportion to the partial pressure because of influence of the amorphous carbon.

In the present embodiment, the partial pressure of the carbon source gas in the reaction tube 1 is maintained to be in a range between 1.0 Torr and 2.0 Torr so that excess carbon source gas is not supplied to the catalyser. Accordingly, the caulking to the catalyser is limited. Since the activity of the catalsyer is maintained, the carbon nano-tube is stably grown.

When the partial pressure of the carbon source gas is lower than 1.0 Torr, the concentration of the carbon source gas is low. Thus, the carbon nano-tube is hardly grown. When the partial pressure is higher than 2.0 Torr, the amorphous carbon is separated out on the catalyser. Thus, the growth of the carbon nano-tube stops, so that the carbon nano-tube is not stably formed.

The partial pressure of the carbon source gas may be set as an initial pressure in the beginning of the growth.

### Second Embodiment

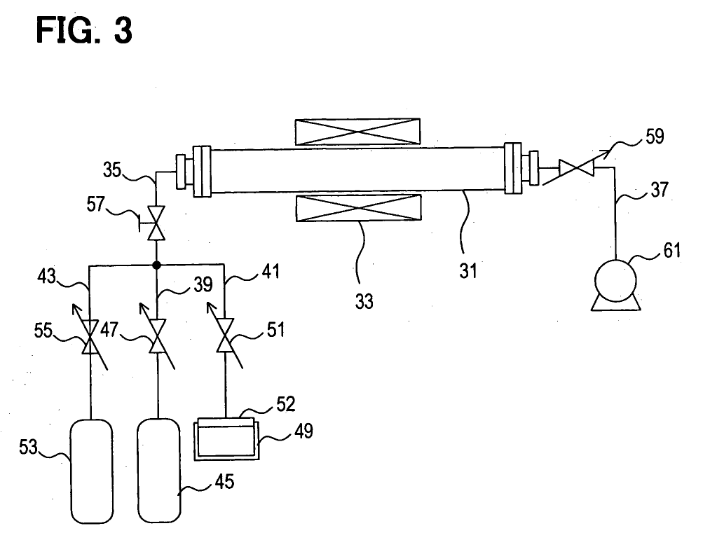

In FIG. 3, carbon nano-tube manufacturing equipment according to a second embodiment includes a reaction tube 31, a ring electric furnace 33, a gas supply pipe 35 and a gas discharge pipe 37. In the reaction tube 31, the vertically-oriented carbon nano-tube is formed by a chemical vapor deposition method. The ring shaped electric furnace 33 heats the reaction tube 31. The gas supply pipe 35 supplies a raw material gas to the reaction tube 31. The gas discharge pipe 37 discharges the gas from the reaction tube 31 after the gas reacts in the reaction tube 31.

The gas supply pipe 35 is connected to both of a first gas supply pipe 39, a second gas supply pipe 41 and a third gas supply pipe 43. The first gas supply pipe 39 supplies the carrier gas including the hydrogen gas and the argon gas. The second gas supply pipe 41 supplies the ethanol. The third gas supply pipe 43 supplies oxidized gas including oxygen gas and argon gas to the reaction tube 31.

The first gas supply pipe 39 is coupled with a first gas cylinder 45 via a first valve 47. In the first gas cylinder 45, the carrier gas is filled. The first valve 17 adjusts the flowing amount of the carrier gas.

The second gas supply pipe 41 is coupled with an ethanol vessel 49 via a second valve 51. The ethanol is stored in the vessel 49. The second valve 51 adjusts the ethanol gas flow amount. A heater 52 for holding the temperature of the ethanol is formed on the vessel 49.

The third gas supply pipe 43 is coupled with a second gas cylinder 53 via a third valve 55. In the second gas cylinder 53, the oxidized gas is filled. The third valve 55 adjusts the flowing amount of the oxidized gas.

In the gas supply pipe 35, a fourth valve 57 is arranged between the reaction tube 31 and the first to third gas supply pipes 39, 41, 43. Specifically, the fourth valve 57 is disposed on a downstream side from each connection between the gas supply pipe 35 and the first to third gas supply pipes 39, 41, 43. The fourth valve 57 opens and closes the pipe 35 to supply and to stop supplying the gas in the reaction tube 31.

In the gas discharge pipe 37, a fifth valve 59 is arranged between the reaction tube 31 and a vacuum pump 61. Specifically, the vacuum pump 61 is disposed on the downstream side from the fifth valve 59. The fifth valve 59 adjusts the gas flow amount discharged from the reaction tube 31. The vacuum pump 61 vacuates the inside of the reaction tube 31.

The first to fifth valves 47, 51, 55, 57, 59 are electro-magnetic valves for opening and closing the pipes 35, 37, 39, 41, 43 based on instruction signals from electronic controller (not shown). Alternatively, the valves 47, 51, 55, 57, 59 may be operated manually.

The manufacturing method of the carbon nano-tube will be explained.

A substrate, on which the carbon nano-tube catalyser is applied, is inserted in the reaction tube 31.

<First step of First Growth Process>

First, the fifth valve 59 is opened, and the vacuum pump 61 is operated. Thus, the reaction tube 31 is evacuated.

The opening degree of each of the first, third, and fourth valves 47, 57, 59 is controlled so that the carrier gas having the gas flow amount of 300 sccm is supplied to the tube 31. Thus, the inner pressure of the reaction tube 31 is maintained to 300 Torr (i.e., 39.9 kPa). The substrate temperature is increased to the growth temperature of the carbon nano-tube of 840° C.

Next, the first valve 47 is closed, and the reaction tube 1 is evacuated.

Then, the opening degree of each of the first, second, fourth and fifth valves 47, 51, 57, 59 is controlled so that the ethanol gas and the carrier gas are introduced in the reaction tube 31 with predetermined gas flow amounts, respectively. Thus, the inner pressure of the reaction tube 31 is maintained to 2.0 Torr (i.e., 266 Pa). Specifically, the gas flow amount of the ethanol gas is 20 sccm, and the gas flow amount of the carrier gas is 20 sccm. The partial pressure of the ethanol gas is maintained to 1.0 Torr (i.e., 133 Pa).

The substrate temperature is maintained at 840° C., and the carbon nano-tube is grown on the substrate for 10 minutes.

<Second step of First Growth Process>

Then, the reaction tube 31 is evacuated again. Specifically, the first to fourth valves 47, 51, 55, 57 are closed, and the fifth valve 59 is opened, so that the tube 31 is evacuated.

Next, the third valve 55 and the fourth valve 57 are opened, so that the argon gas including the oxide gas as the oxidized gas having a predetermined gas flow amount (e.g., 300 sccm) is flown in the tube 31 at a predetermined temperature (e.g., 700° C.) for a predetermined time (e.g., 10 minutes). Thus, the amorphous carbon on the catalyser is removed. The oxygen concentration in the oxidized gas is in a range between 100 ppm and 500 ppm. In the present embodiment, the oxygen concentration is 100 ppm.

<Second Growth Process>

Then, the reaction tube 31 is evacuated again. The opening degree of each of the first, second, fourth and fifth valves 47, 51, 57, 59 is controlled so that the ethanol gas having the gas flow amount of 20 sccm and the carrier gas having the gas flow amount of 20 sccm are flown in the tube 31, and the partial pressure of the ethanol gas is maintained to 1.0 Torr. Thus, the carbon nano-tube is grown at 840° C. for 10 minutes.

The first growth process and the second growth process are alternately repeated. Specifically, the carbon nano-tube growing process and the amorphous carbon removing process are alternately repeated. Thus, the carbon nano-tube having large length is formed.

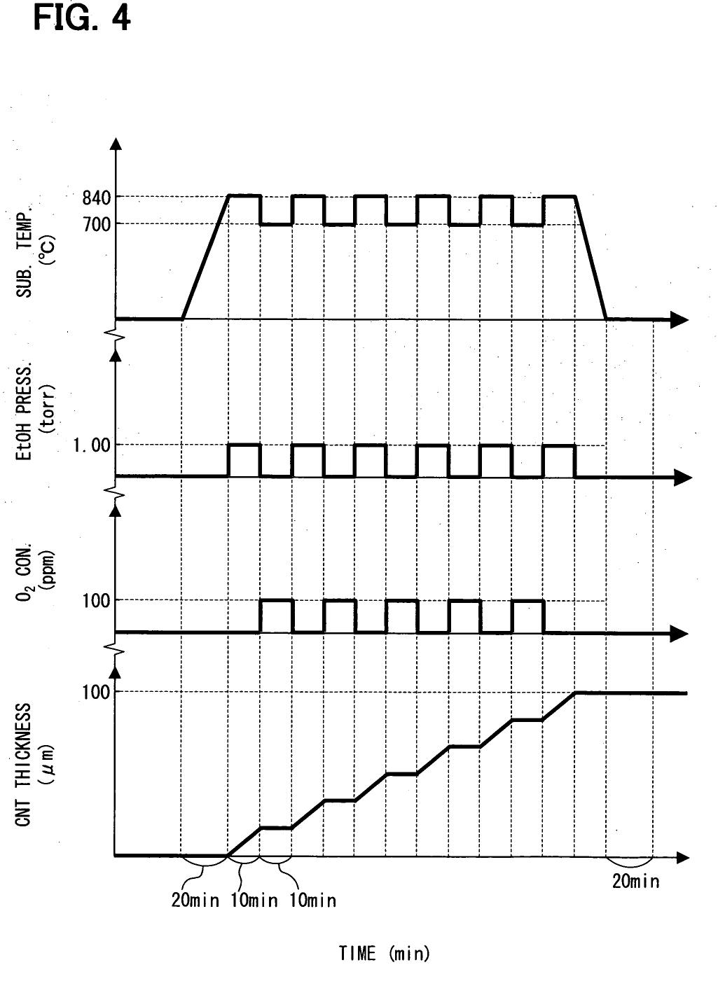

In this embodiment, as shown in FIG. 4, six first growth processes are repeated. The vertically-oriented carbon nano-tube having the fiber length of 100 micro meters is obtained. Here, in the second growth process, the substrate temperature is reduced to 700° C. from 840° C.

Here, when the substrate temperature in the second growth process is set to 400° C., 500° C., or 600° C., similar result is obtained. Further, when the oxygen concentration in the oxidized gas is set to 200 ppm, 300 ppm, 400 ppm or 500 ppm, similar result is obtained.

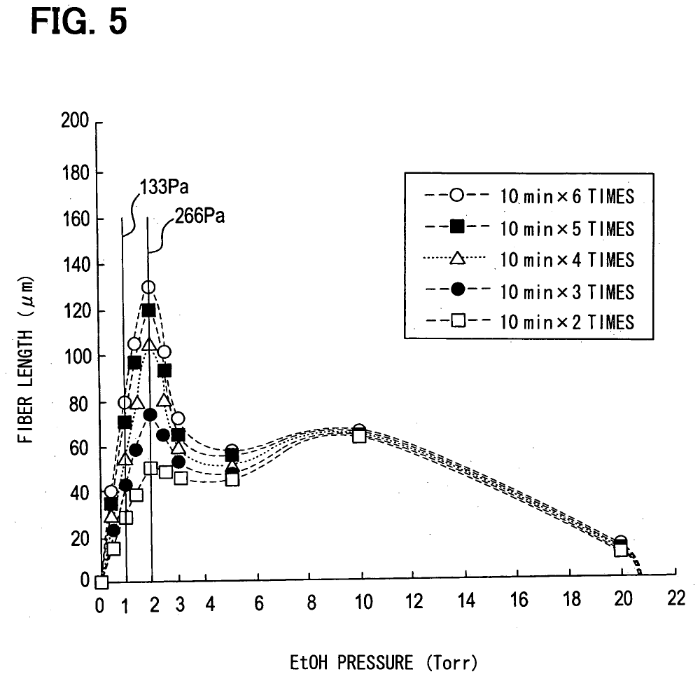

Another experiment is performed so that the result shown in FIG. 5 is obtained. Here, the partial pressure of the ethanol gas and the number of repeating times are changed so that the relationship between the ethanol partial pressure and the fiber length of the carbon nano-tube is measured. Specifically, the number of the repeating times is changed from two times to six times.

After the carbon nano-tube is grown on the substrate, the oxidized gas is supplied to the tube 31 so that the amorphous carbon is removed. Accordingly, even when the carbon nano-tube is grown on the substrate repeatedly, the catalyser can function for forming the carbon nano-tube. Thus, the carbon nano-tube is easily grown on the substrate.

When the ethanol partial pressure is in a range between 1.0 Torr and 2.0 Torr, the fiber length of the carbon nano-tube is increased in proportion to the partial pressure. However, when the ethanol partial pressure is higher than 2.0 Torr, the fiber length of the carbon nano-tube is decreased because of influence of the amorphous carbon.

In the present embodiment, the catalyser is activated again so that the activity of the catalyser is maintained to be high. Thus, the carbon nano-tube having the large length is formed.

When the partial pressure of the carbon source gas is lower than 1.0 Torr, the concentration of the carbon source gas is low. Thus, the carbon nano-tube is hardly grown even when the carbon nano-tube is repeatedly formed. When the partial pressure is higher than 2.0 Torr, the amorphous carbon is separated out on the catalyser. Thus, the growth of the carbon nano-tube stops even when the catalyser is oxidized by the oxidized gas (i.e., even when the amorphous carbon is removed by the oxidized gas), so that the carbon nano-tube is not stably formed.

The oxidized gas may be oxygen gas or moisture vapor. If the oxidizing power is excessively strong, the carbon nano-tube itself may be oxidized. Accordingly, it is preferred that the oxidized gas is made of moisture vapor. The concentration of the oxidized gas is in a range between 100 ppm and 500 ppm. When the concentration of the oxidized gas is lower than 100 ppm, the oxidizing power is weak. When the concentration of the oxidized gas is higher than 500 ppm, the oxidizing power is excessively strong.

The substrate temperature in the amorphous carbon removing process may be in a range between 400° C. and 700° C. When the substrate temperature is lower than 400° C., the oxidized gas has weak oxidizing power since the moisture and the amorphous carbon do not react with high reactive property. Thus, the amorphous carbon is hardly removed. When the substrate temperature is higher than 700° C., the oxidized gas may burn the carbon nano-tube itself.

### Third Embodiment

Manufacturing equipment according to a third embodiment is the same as that in FIG. 3. In the third embodiment, the catalyser is reduced. A manufacturing method for forming the carbon nano-tube will be explained as follows.

<First Growth Process>

First, the fifth valve 59 is opened, and the vacuum pump 61 is operated. Thus, the reaction tube 31 is evacuated.

Then, the opening degree of each of the first, third and fourth valves 47, 57, 59 is controlled so that the carrier gas having the gas flow amount of 300 sccm is supplied to the tube 31, and the inner pressure of the reaction tube 31 is maintained to 300 Torr (i.e., 39.9 kPa). The substrate temperature is increased to 840° C.

Next, the first valve 47 is closed, and the reaction tube 31 is evacuated.

Then, the opening degree of each of the first, second, fourth and fifth valves 47, 51, 57, 59 is controlled so that the ethanol gas and the carrier gas are flown with predetermined gas flow amounts, respectively, and the inner pressure of the reaction tube 31 is maintained to 2.0 Torr. Specifically, the gas flow amount of the ethanol gas is 20 sccm, and the gas flow amount of the carrier gas is 20 sccm. The partial pressure of the ethanol gas is 1.0 Torr.

The substrate temperature is maintained at 840° C., and the carbon nano-tube is grown on the substrate for 10 minutes.

<Amorphous Carbon Removing Process>

Then, the reaction tube 31 is evacuated again. Specifically, the first to fourth valves 47, 51, 55, 57 are closed, and the fifth valve 59 is opened, so that the tube 31 is evacuated.

Next, the third valve 55 and the fourth valve 57 are opened, so that the argon gas including the oxide gas as the oxidized gas having a predetermined gas flow amount (e.g., 300 sccm) is flown in the tube 31 at a predetermined temperature (e.g., 700° C.) for a predetermined time (e.g., 5 minutes). Thus, the amorphous carbon on the catalyser is removed. The oxygen concentration in the oxidized gas is in a range between 100 ppm and 500 ppm. In the present embodiment, the oxygen concentration is 100 ppm.

<Catalyser Reducing Process>

Then, the reaction tube 31 is evacuated again.

Next, the first and fourth valves 47, 57 are opened, so that the argon gas including the hydrogen gas as a reducing gas is introduced in the tube 31 with a predetermined gas flow amount (e.g., 300 sccm) at a predetermined temperature (e.g., 700° C.) for a predetermined time (e.g., 5 minutes). Thus, the carbon nano-tube growth catalyser is reduced. Here, the concentration of the hydrogen gas in the reducing gas is in a range between 100 ppm and 500 ppm. In the present embodiment, the hydrogen concentration is 100 ppm.

<Second Growth Process>

Then, the reaction tube 31 is evacuated again. The opening degree of each of the first, second, fourth and fifth valves 47, 51, 57, 59 is controlled so that the ethanol gas having the gas flow amount of 20 sccm and the carrier gas having the gas flow amount of 20 sccm are flown in the tube 31, and the partial pressure of the ethanol gas is maintained to 1.0 Torr. Thus, the carbon nano-tube is grown at 840° C. for 130 minutes.

The first to third processes are alternately repeated. Specifically, the carbon nano-tube growing process, the amorphous carbon removing process and the catalyser reducing process are alternately repeated. Thus, the carbon nano-tube having large length is formed.

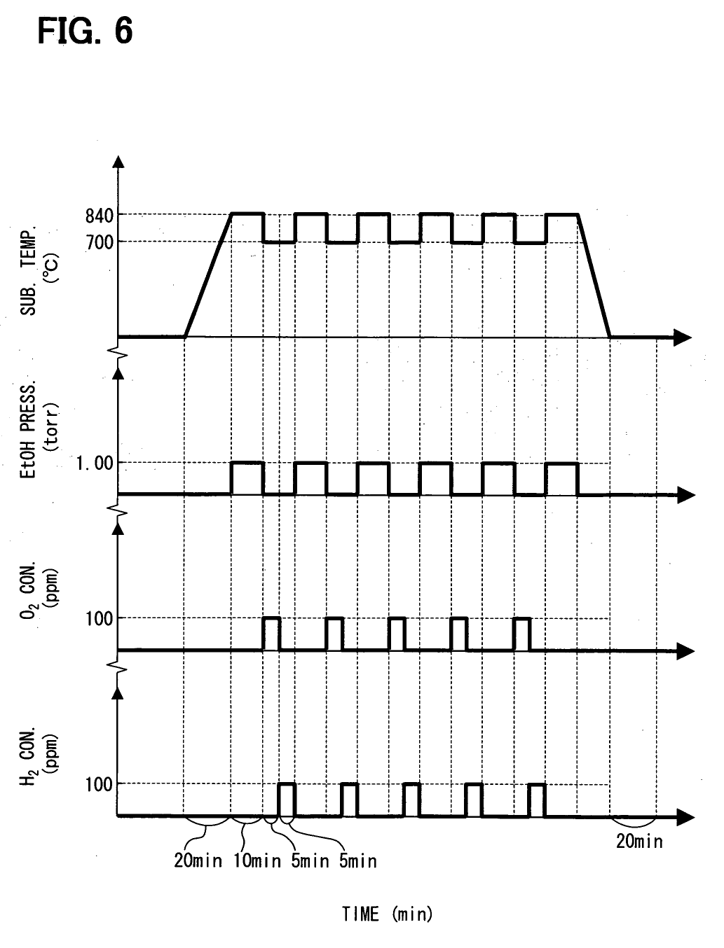

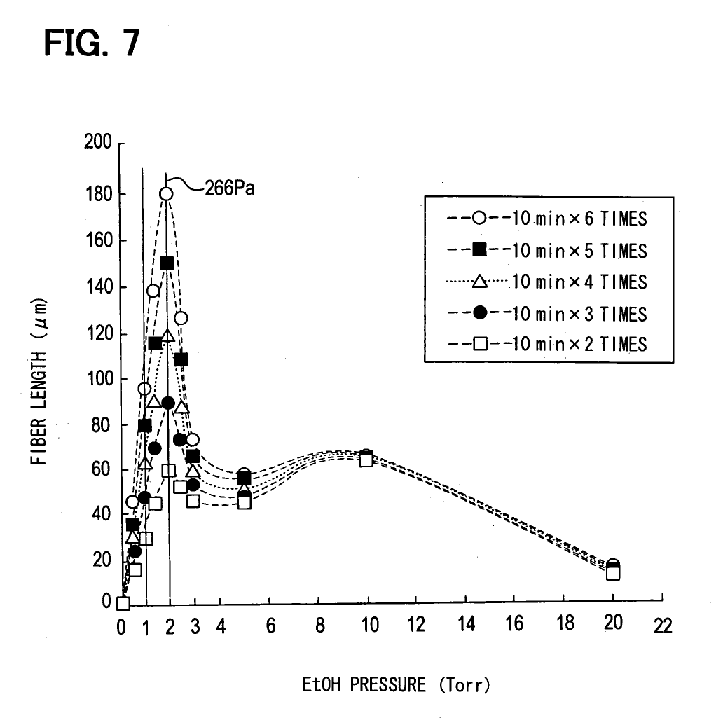

In this embodiment, as shown in FIG. 6, six first growth processes are repeated. The vertically-oriented carbon nano-tube having the fiber length shown in FIG. 7 is obtained. Here, in the amorphous carbon removing process and the catalyser reducing process, the substrate temperature is reduced to 700° C. from 840° C.

Here, when the substrate temperature in the amorphous carbon removing process is set to 400° C., 500° C., or 600° C., similar result is obtained. Further, when the substrate temperature in the catalyser reducing process is set to 400° C., 500° C., or 600° C., similar result is obtained. When the oxygen concentration in the oxidized gas is set to 200 ppm, 300 ppm, 400 ppm or 500 ppm, similar result is obtained. When the hydrogen concentration in the reducing gas is set to 200 ppm, 300 ppm, 400 ppm or 500 ppm, similar result is obtained.

Another experiment is performed so that the result shown in FIG. 7 is obtained. Here, the partial pressure of the ethanol gas and the number of repeating times are changed so that the relationship between the ethanol partial pressure and the fiber length of the carbon nano-tube is measured. Specifically, the number of the repeating times is changed from two times to six times.

After the carbon nano-tube is grown on the substrate, the oxidized gas is supplied to the tube 31 so that the amorphous carbon is removed. Further, the reducing gas is flown in the tube 31 so that the catalyser is reduced. Accordingly, even when the carbon nano-tube is grown on the substrate repeatedly, the catalyser can function for forming the carbon nano-tube, i.e., the activity of the catalyser is not reduced. Thus, the carbon nano-tube is easily grown on the substrate.

In the present embodiment, the concentration of the reducing gas is in a range between 100 ppm and 500 ppm. When the concentration of the reducing gas is lower than 100 ppm, the reducing power is weak. When the concentration of the reducing gas is higher than 500 ppm, the reducing power is excessively strong. Thus, the particle of the catalyser may be migrated, i.e., replaced and/or agglutinated, so that the diameter of the particle of the catalyser increases. Thus, the activity of the catalyser is reduced.

The substrate temperature in the catalyser reducing process may be in a range between 400° C. and 700° C. When the substrate temperature is lower than 400° C., the reducing gas has weak reducing power so that the oxidized catalyser is not sufficiently reduced. When the substrate temperature in the catalyser reducing process is higher than 700° C., the particle of the catalyser is migrated, i.e., replaced and/or agglutinated, so that the diameter of the particle of the catalyser increases. Thus, the activity of the catalyser is reduced.

When the ethanol partial pressure is in a range between 1.0 Torr and 2.0 Torr, the fiber length of the carbon nano-tube is increased in proportion to the partial pressure. However, when the ethanol partial pressure is higher than 2.0 Torr, the fiber length of the carbon nano-tube is decreased because of influence of the amorphous carbon.

Although the carbon source gas is the ethanol gas, the carbon source gas may be a methanol gas, an acethylene gas, an ethylene gas, a methane gas or the like.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A method for manufacturing a carbon nano-tube by a chemical vapor deposition comprising:
introducing a carbon source gas into a reaction chamber;
growing the carbon nano-tube by using a catalyser; and
maintaining a pressure of the carbon source gas in the reaction chamber in a range between 1.0 Torr and 2.0 Torr so that the carbon nano-tube is formed.

2. The method according to claim 1,
wherein the carbon source gas is an ethanol gas, a methanol gas, an acethylene gas, an ethylene gas, or a methane gas,
wherein the growing the carbon nano-tube is performed at around 840° C., and
wherein the catalyser is made of Co, Mo, alloy of Co and Mo, Co oxide or Mo oxide.

3. A method for manufacturing a carbon nano-tube by a chemical vapor deposition comprising:
introducing a carbon source gas into a reaction chamber;
growing the carbon nano-tube by using a catalyser;
maintaining a pressure of the carbon source gas in the reaction chamber in a range between 1.0 Torr and 2.0 Torr so that the carbon nano-tube is formed; and
removing an amorphous carbon attached on the catalyser with an oxidized gas after the maintaining the pressure,
wherein the maintaining the pressure is performed after the maintaining the pressure and the removing the amorphous carbon are alternately repeated at least one time.

4. The method according to claim 3,
wherein the removing the amorphous carbon is performed with an inert gas including the oxidized gas at a temperature in a range between 400° C. and 700° C.

5. The method according to claim 4,
wherein the carbon source gas is an ethanol gas, a methanol gas, an acethylene gas, an ethylene gas, or a methane gas,
wherein the oxidized gas includes an oxygen gas and an argon gas,
wherein an oxygen concentration in the oxidized gas is in a range between 100 ppm and 500 ppm,
wherein the growing the carbon nano-tube is performed at around 840° C., and
wherein the catalyser is made of Co, Mo, alloy of Co and Mo, Co oxide or Mo oxide.

6. A method for manufacturing a carbon nano-tube by a chemical vapor deposition comprising:
introducing a carbon source gas into a reaction chamber;
growing the carbon nano-tube by using a catalyser;
maintaining a pressure of the carbon source gas in the reaction chamber in a range between 1.0 Torr and 2.0 Torr so that the carbon nano-tube is formed;
removing an amorphous carbon attached on the catalyser with an oxidized gas after the maintaining the pressure; and
reducing the catalyser with a reducing gas after the removing the amorphous carbon,
wherein the maintaining the pressure is performed after the maintaining the pressure, the removing the amorphous carbon and the reducing the catalyser are alternately repeated at least one time.

7. The method according to claim 6,
wherein the removing the amorphous carbon is performed with an inert gas including the oxidized gas at a temperature in a range between 400° C. and 700° C., and
wherein the reducing the catalyser is performed with an inert gas including the reducing gas at a temperature in a range between 400° C. and 700° C.

8. The method according to claim 6,
wherein the reducing the catalyser is performed after the removing the amorphous carbon.

9. The method according to claim 7,
wherein the carbon source gas is an ethanol gas, a methanol gas, an acethylene gas, an ethylene gas, or a methane gas,
wherein the oxidized gas includes an oxygen gas and an argon gas, wherein an oxygen concentration in the oxidized gas is in a range between 100 ppm and 500 ppm,
wherein the reducing gas includes a hydrogen gas and an argon gas,
wherein an hydrogen concentration in the reducing gas is in a range between 100 ppm and 500 ppm,
wherein the growing the carbon nano-tube is performed at around 840° C., and
wherein the catalyser is made of Co, Mo, alloy of Co and Mo, Co oxide or Mo oxide.
